(19) United States
(12) Patent Application Publication
(10) Pub. No.: US 2024/0376998 A1
(43) Pub. Date: Nov. 14, 2024

(54) METHOD FOR DETECTING AND QUANTIFYING VALVE STICTION IN PROCESS CONTROL LOOPS

(71) Applicants: SYNCRUDE CANADA LTD. in trust for the owners of the Syncrude Project as such owners exist now, Calgary (CA); GOVERNORS OF THE UNIVERSITY OF ALBERTA, Edmonton (CA)

(72) Inventors: Seshu Kumar DAMARLA, Edmonton (CA); Xi (Chris) SUN, Fort McMurray (CA); Biao HUANG, Edmonton (CA); Fangwei XU, Fort McMurray (CA); Ashish SHAH, Fort McMurray (CA); Joseph AMALRAJ, Fort McMurray (CA)

(21) Appl. No.: 18/315,714

(22) Filed: May 11, 2023

(51) Int. Cl. F16K 37/00; G05B 13/04; G05B 23/02

(52) U.S. Cl. CPC F16K 37/0083; G05B 13/041; G05B 23/0235; G05B 23/024

(57) ABSTRACT

A standard deviation based method for detection and quantification of stiction in a control valve in a process control loop is provided, the process control loop having a sensor for measuring a process parameter or variable (PV) and a controller for controlling the control valve, whereby the controller compares the process parameter or variable (PV) to a set point value (SP) for a stable operation of the process and provides an output signal (OP) for controlling the control valve.

### TECHNICAL FIELD

The following relates to process control systems and more specifically to a method and system for detection and quantification of valve stiction in a process control loop.

### BACKGROUND

Process facilities such as oil sands industries, mineral processing plants, crude oil refineries, fertilizer industries, etc. are managed by automation systems employing feedback controllers for keeping track of and adjustment of physical properties or characteristics (such as flowrate, temperature, pressure, level, concentration, etc.) of a process. The automation systems are accountable for optimal process operation to maximize profitability while ensuring safe operation.

A block diagram of a typical feedback control loop that controls a conventional control valve 20 that regulates fluid flow to process 30 is shown in FIG. 1 (PRIOR ART). The output of process 30 (which may be temperature, pressure, level and the like) is measured by sensor/transmitter 40. The measured process variable is referred to as PV. The measured signal from sensor/transmitter 40, i.e., PV, is sent to controller 50, which controller 50 controls the opening and the closing of control valve 20. Controller 50 includes hardware, software, firmware or combinations thereof for controlling the operation of valve 20. Controller 50 compares PV with the desired process output, which is referred to as a set-point variable (SP), to compute error. In other words, controller 50 determines if the flow/pressure/temperature level of the process, which is controlled by control valve 20, is above or below the set point (SP) and will calculate Error (e=SP−PV).

Based on the error, the controller 50 generates its output signal (OP) to alter the position of the control valve 20 in order to maintain PV at or around SP. Hence, based on the signal (OP) from the controller 50, the valve 20 will open/close to start/restrict flow accordingly. When the valve position varies, the flowrate of fluid passing through the control valve 20 (i.e., it is input to the process) changes. The control valve 20 is a crucial asset of the control loop and its performance can have a great impact on the performance of the control loop. A control valve being operated in closed loop may behave abnormally over time and such abnormal behavior can interfere with the normal operation of the valve and successively deteriorate the control loop performance. Control valve faults often witnessed in industries are faulty diaphragm, packing leakage, corroded valve seat or plug, undersized or oversized valve, valve hysteresis, stiction, etc. In addition to the control valve faults, external oscillatory disturbances (upstream or downstream process upsets), poor control tuning and sensor malfunction can contribute to poor performance of the control loop.

The consequences of each of the problems mentioned above can be realized through the presence of a variety of unfavorable oscillations in OP and PV. The oscillations point to the occurrence of one or more problems. Valve stiction is an established industrial problem, which is encountered by maintenance or control engineers on a regular basis. In the absence of stiction, valve positioner data and OP have a linear relationship (i.e., valve positioner data is virtually equal to OP). However, in the presence of stiction, this ideal relation is disturbed and OP is nonlinearly related to the valve positioner data. Stiction is quantified as a percentage of valve travel or the span of the control signal (0-100). In practice, stiction less than 0.2% may not create serious problems but moderate to severe stiction can cause plant upsets or trips.

Valve travel (or bump test) is a popular intrusive test that can be used to detect sticky control valves at ease. The intrusive methods interfere with operation of in-service control valves, which in turn disturbs running plant. It is impractical to test each malfunctioning valve with the intrusive methods. Therefore, non-intrusive methods have been received greater attention. Canada Patent No. 2,571,022 discloses an automatic methodology for detection and quantification of stiction. The methodology detects nonlinearity in the control loop with the help of the sensitivity of bicoherence. Once non-linearity is identified, PV and OP signals are filtered, and then either PV or OP is fitted to rectangle or triangular signals for stiction detection. Canada Patent No. 2,870,918 provides cross limit control for effective operation of furnace and stiction detection. European Patent No. 3,252,557 gives a non-intrusive method, based on statistical quality control, for stiction detection. This method requires valve positioner data and OP. U.S. Pat. No. 7,274,995 illustrates a method for identification of defects in control valve by determining peaks in PV and extreme points in OP. U.S. Pat. No. 7,318,350 discloses a valve monitoring method based on acoustic emission data of the control valve. U.S. Pat. No. 7,865,334 demonstrates a simple method using area ratio for the root cause of oscillations in the control loop.

A hierarchical analysis of oscillating control loops, by performing a series of tasks such as nonlinearity index calculations, determining the presence of an elliptic shape in PV versus OP plot and oscillation index, is discussed in U.S. Pat. No. 9,429,938. Zheng et al. (2021) introduces a new stiction detection and quantification method that is based on moving window approach and K-means clustering. Besides detecting sticky valves, this method can also identify abrupt valve closures. Damarla at el. (2021) presents a practical linear regression based method for detection and quantification of stiction in industrial control loops. Damarla et al. (2022) discusses a different approach for stiction detection. This approach fits sigmoid function (or logistic function) to the data: first derivative of PV and OP. If the given valve has stiction, the sigmoid function fits the data reasonably and correlation between OP and the output of the sigmoid function is above 0.5.

All of the above methods possess weaknesses. The methods disclosed in Canada Patent No. 2,571,022 and U.S. Pat. No. 9,429,938 depend on the presence of triangular or rectangular shapes in OP or PV, respectively. In practice, process data is often contaminated with noise, which can distort the triangular or rectangular shapes. In such circumstances, these methods may yield incorrect verdict. The invention discussed in European Patent No. 3,252,557 requires measurements of valve positioner data, which are only available in smart valves. This kind of data is difficult to obtain if industries use conventional or non-smart control valves. This type of non-smart control valves are still employed in some industries. The approach mentioned in U.S. Pat. No. 7,318,350 needs additional hardware to collect acoustic emission data, which increases operating cost of plants. The methods presented in U.S. Pat. Nos. 9,429,938 and 7,274,995 entail a significant number of computations. Whereas the methods given in Da et al. (2021) and Damarla et al. (2022) were designed to work in offline mode.

The foregoing discussion suggests that there is a need in the industry for a method and apparatus to detect and quantify stiction in process control loops, which may have one or more of the following characteristics: only require routine operation data; does not need additional sensor to collect non-routine data such as acoustic emission; does not require to perform a lot of operations to detect stiction; does not depend on triangular or rectangular shape in OP or PV, respectively; works well in real time; can quantify degree of stiction; and can be easily implemented in distributed control system (DCS) or centralized process information database (PI database) with minimal computational load.

### SUMMARY

A non-invasive and data-driven methodology for recognizing sticky control valves can preclude the need for manual inspection or the use of an invasive method. The following method is a simple and practical method that can detect and quantify stiction in a control valve being operated in a control loop without user involvement. The method does not need to be supplemented by intrusive methods. If valve positioner data is accessible, stiction can effortlessly be detected by relating the valve positioner data to OP. In the absence of the valve positioner data, stiction detection can become very difficult due to the presence of noise, process upsets and multi-loop interactions. The method disclosed herein detects and quantifies stiction using the process variable signal (PV) and the controller output signal (OP). The method does not require valve positioner data from a smart control valve. The method can be implemented in an offline or online fashion. For example, the method can be integrated into a distributed control system (DCS), which is a computerized control system for a process or plant usually with many control loops, in which automatic controllers are distributed throughout the system. Irrespective of the mode of deployment, the method can work in a fully automatic mode.

According to one aspect, there is provided a method for identifying a malfunctioning control valve due to stiction in a process control loop, the process control loop having a sensor for measuring a process parameter or variable (PV) and a controller for controlling the control valve, comprising the steps of:
(a) providing a set point value (SP) for a stable operation of the process, where the controller compares the process parameter or variable (PV) with the SP and provides an output signal (OP) for controlling the control valve;
(b) collecting PV and OP signals from the control loop for a period of time;
(c) dividing the optionally filtered PV signal and the OP signal into a number (M) of non-overlapping data windows, each PV or OP data window having a number (wₛ) of distinct PV or OP data points;
(d) determining the mean value of the PV and OP data points in each of the PV and OP data windows;
(e) computing a standard deviation of the PV data points present in each of the PV windows (STD_{PV}) and a standard deviation of the OP data points in each of the OP windows (STD OF);
(f) calculating and storing a standard deviation ratio (R) (STD_{OP}/STD_{PV}) for each OP/PV window pair;
(g) computing stiction(S) in each OP/PV window pair by comparing the standard deviation ratios (R) of each PV/OP window pair to a first predefined threshold value (β) and if the standard deviation ratio (R) is equal to or greater than β then S is 1 and if the standard deviation ratio (R) is less than β then S is 0; and
(h) computing a stiction index (SI) by adding the S values obtained in each OP/PV window pair divided by the number of windows (M);
whereby when SI is 0 there is no stiction and when SI is greater than zero there is stiction.

In one embodiment, any noise in the PV signal is filtered out prior to step (c). In one embodiment, SI is compared to a second predefined threshold value (Φ) whereby if SI is equal to or greater than Φ an operator receives a signal indicating that the control valve frequently gets stuck in a given period of operation.

In one aspect, the method further comprises quantifying a degree of stiction (Y) for the control valve, comprising the steps of:
(i) determining which of the M windows have an S value equal to 1, which windows are referred to as stiction windows;
(j) determining which stiction windows are non-consecutive and which stiction windows are consecutive;
(k) for each non-consecutive stiction window, subtract the last OP data point in that window from the first OP data point in that window and convert the resulting number to an absolute number to obtain a stiction band value (δ) for each non-consecutive window;
(1) for each group of consecutive stiction windows, subtract the last OP data point in the last consecutive stiction window of that group from the first OP data point in the first consecutive stiction window of that group and convert the resulting number to an absolute number to obtain a stiction band value (δ) for each group of consecutive windows;
whereby the degree of stiction (Ψ) is the highest stiction band value (δ) determined in steps (k) and (l).

Additional aspects and advantages of the present method will be apparent in view of the description, which follows. It should be understood, however, that the detailed description and the specific examples, while indicating preferred embodiments, are given by way of illustration only, since various changes and modifications will become apparent to those skilled in the art from this detailed description.

### BRIEF DESCRIPTION OF THE DRAWINGS

The method provided will now be described by way of an exemplary embodiment with reference to the accompanying simplified, diagrammatic, not-to-scale drawings:

FIG. 1 is a block diagram of a typical control loop.

FIG. 2 is a signature plot of a sticky control valve.

FIG. 3 shows the closed loop signals of a flow control loop having sticky control valve.

FIG. 4 shows the closed loop signals of a concentration control loop having non-sticky valve.

FIG. 5 is a decision flow diagram of the methodology for detecting stiction.

FIG. 6 is a decision flow diagram of the methodology for quantifying stiction.

FIG. 7 shows stiction signal S obtained from the stiction detection procedure described in FIG. 5.

FIG. 8A shows closed loop signals of CHEM 1.

FIG. 8B shows standard deviation ratio computed for CHEM 1.

FIG. 8C shows stiction signal S obtained for CHEM 1.

FIG. 9A shows closed loop signals of CHEM 10.

FIG. 9B shows standard deviation ratio computed for CHEM 10.

FIG. 9C shows stiction signal S obtained for CHEM 10.

FIG. 10A shows closed loop signals of MIN 1.

FIG. 10B shows standard deviation ratio computed for MIN 1.

FIG. 10C shows stiction signal S obtained for MIN 1.

FIG. 11A shows closed loop signals of CHEM 13.

FIG. 11B shows standard deviation ratio computed for CHEM 13.

FIG. 11C shows stiction signal S obtained for CHEM 13.

FIG. 12A shows closed loop signals of PAP 4.

FIG. 12B shows standard deviation ratio computed for PAP 4.

FIG. 12C shows stiction signal S obtained for PAP 4.

FIG. 13A shows closed loop signals of a steam flow loop from an oil sands industry.

FIG. 13B shows standard deviation ratio computed for the steam flow loop.

FIG. 13C shows stiction signal S obtained for the steam flow loop.

FIG. 13D shows stiction detection for the steam flow loop.

### DETAILED DESCRIPTION

A method is provided to determine whether a given process control loop is suffering from valve stiction. In addition, the method may further comprise quantifying the degree of stiction in a given control loop.

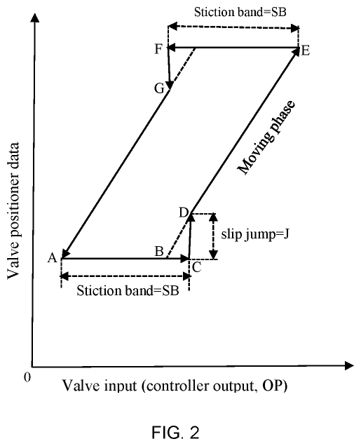

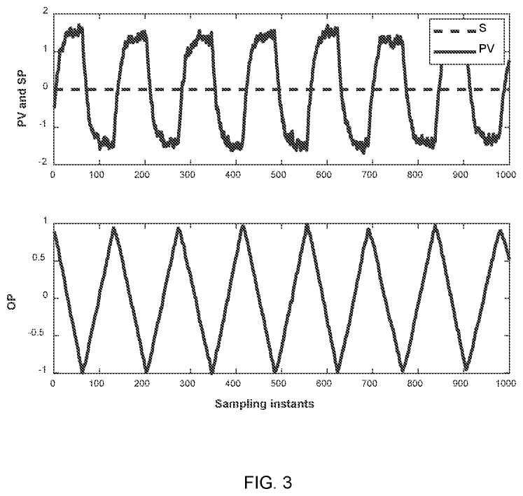

With reference now to FIG. 2, FIG. 2 illustrates the behaviour of a sticky control valve. As a result of the presence of stiction, it can be seen in FIG. 2 that controller output (OP) has a nonlinear relation with valve positioner data (instead of a linear relation, as in the case with a non-sticky valve (Choudhury et al. (2006)). The closed loop signals of flow control loop, adopted from refinery (Jelali and Huang (2009)), with a sticky valve are shown in FIG. 3. The representative curve displayed in FIG. 2 is shaped by stiction band, slip-jump and moving phase. During stiction, the valve positioner data stays at a constant value while OP is moving from point A through point C. Owing to this, process input (i.e., flow of fluid passing through the valve) does not change, causing process variable (PV given in FIG. 3) to remain constant or vary slowly. This steady state phase in PV (given in FIG. 3) lasts as long as the valve stem does not budge. Therefore, an offset is created between PV (given in FIG. 3) and set point (SP given in FIG. 3), which forces the controller to vary OP. When cumulative change in OP is adequate to push the valve, the valve is released from stiction and abruptly jumps from point C to point D (FIG. 2), which is termed the slip-jump. From point D onwards, the valve stem position keeps altering without pause (moving phase) so that both OP and PV change and are in non-steady state.

When the valve stem is in motion, PV in FIG. 3 keeps varying and this state is called transient (or non-steady) state. The bottom graph shows the OP values (solid line) per sampling instances and the top graph shows the PV values (solid line) per sampling instances. Sampling instances, for example, in a PI database, are in minutes whereas in a distributed control system (DCS) the sampling instances can be in seconds. The hatched line in the top graph represents the set point (SP). The transient state commences every time the valve overcomes stiction. When PV deviates from SP, the controller changes OP in an effort to bring PV back to SP. When OP begins to decrease at point E, as shown in FIG. 2, the valve is blocked a second time and, as a result, PV enters a steady state. For a given time period, the valve may stick several times; consequently, PV can have numerous similar or dissimilar steady states (or pseudo steady states because of noise) depending upon how SP changes.

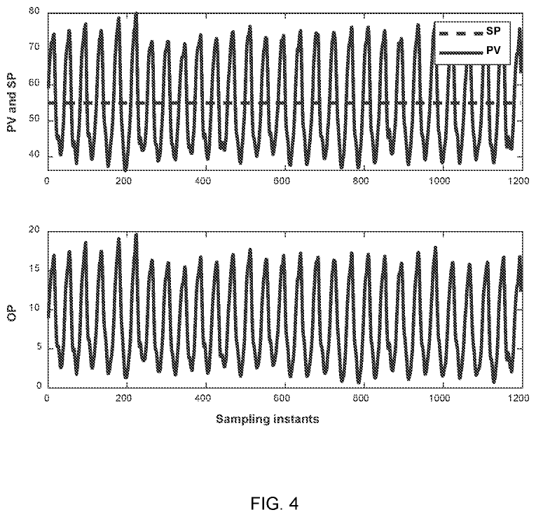

FIG. 4 shows the oscillating PV and OP of a concentration control loop, taken from a paper industry (Jelali and Huang (2009)), having a healthy valve. Once again, the bottom graph shows the OP values (solid line) per sampling instances and the top graph shows the PV values (solid line) per sampling instances. The hatched line in the top graph represents the set point (SP). Since the oscillations in this control loop are induced by a non-stiction condition (inappropriate controller tuning) and the valve is free of stiction, PV and OP continuously vary and there are no steady states in PV. The above brings into light important points that when the valve stem reposes, PV stays unchanged (i.e., PV is in steady state) and OP keeps varying (i.e., OP is in transient state). If the valve stem position is changing, both PV and OP vary (in the same direction or the opposite direction) i.e., both PV and OP are in transient state.

As shown above, sticky control valves in industrial control loops can be detected by identifying steady state and non-steady (transient) state periods in PV and OP signals, respectively. This is the basis for the method of the present application.

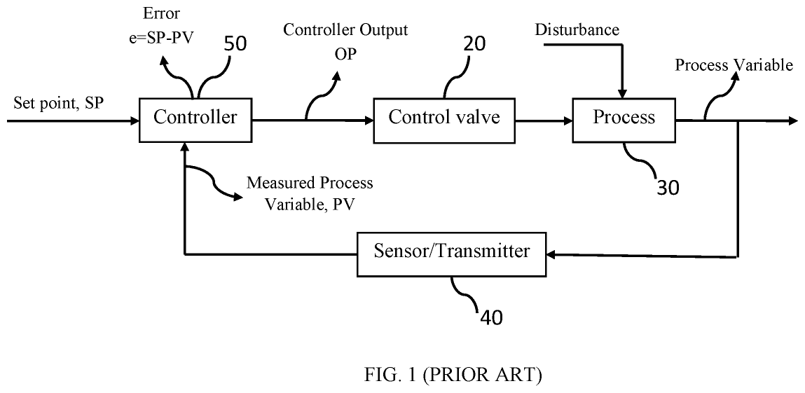

FIG. 5 illustrates one embodiment of a method for determining whether a valve in a given process control loop, for example, a control loop such as illustrated in FIG. 1, is suffering from valve stiction. The control loop as shown in FIG. 1 is for illustration only and other systems may be used without departing from the scope of this disclosure. With reference now to FIG. 5, the method 100 for detecting valve stiction can be described as follows. To start, at step 102A, values for wₛ (window size). β (threshold value for standard deviation ratio) and Φ (threshold value for stiction index) will be entered by the user into the program, which values are described in more detail below. At step 102B, PV and OP signals are collected from the control loop, whereby the sensor in the control loop provides the PV signals and the controller provides the OP signals. Optionally, if noise is present, the noise is filtered out from the PV signal and the OP signal (step 104), with the help of wavelets or other methods used to remove noise.

At step 106, the PV and OP signals are then be divided into a number of windows, each window containing a certain number of data points (or samples). The number of data points (samples) per window is referred to as window size or wₛ and the number of windows is referred to as M. For example, it was found that a window size (wₛ) of seven (7) data points (samples) worked well in the present method. Thus, as previously mentioned, to start, wₛ is chosen and the PV and OP data signals are separated accordingly in step 106.

Step 108 involves determining the mean value for PV and OP data points in each window. This is determined as follows. The first wₛ data points of the PV signal are treated as the first data window Pᵢ₌₁.

$${P}_{i = 1} = PV ( 1 : {w}_{s} ) \qquad ( 1 )$$

Similarly, the first wₛ data samples of the OP signal are assigned to the data window Qᵢ₌₁.

$${Q}_{\dot{i} = 1} = OP ( 1 : {w}_{s} ) \qquad ( 2 )$$

The mean of the data points in the data window Pᵢ₌₁ is computed using the following expression.

$${\tilde{P}}_{i = 1} = \frac{PV ( 1 ) + PV ( 2 ) + … + PV ( {w}_{s} )}{{w}_{s}} \qquad ( 3 )$$

Similarly, the mean of the data points in the data window Qᵢ₌₁ is computed using the following expression.

$${\tilde{Q}}_{i = 1} = \frac{OP ( 1 ) + OP ( 2 ) + … + OP ( {w}_{s} )}{{w}_{s}} \qquad ( 4 )$$

The above calculations are repeated for Pᵢ₌₂ and Qᵢ₌₂, Pᵢ₌₃ and Qᵢ₌₃, etc., up to and including P_{i=M} and Q_{i=M}.

Once all of the mean values are calculated for each window, step 110 involves determining the standard deviation for the PV and OP data points in each window (std^{PV} and std^{OP} respectively) as follows.

Standard deviation (stdᵢ₌₁^{pv}) of the data points in the Pᵢ₌₁ window is computed using the following expression.

$${std}_{i = 1}^{pv} = \sqrt{\frac{{\sum }_{j = 1}^{ws} {( {PV}_{j} - {\tilde{P}}_{i = 1} )}^{2}}{{w}_{s} - 1}} \qquad ( 5 )$$

where \tilde{P}ᵢ₌₁ is the mean of the data points in the data window Pᵢ₌₁, PVⱼ is the j^{th} data point in the data window Pᵢ₌₁.

Likewise, standard deviation (stdᵢ₌₁^{op}) of the data points in the Qᵢ₌₁ window is calculated:

$${std}_{i = 1}^{op} = \sqrt{\frac{{\sum }_{j = 1}^{ws} {( {OP}_{j} - {\tilde{Q}}_{i = 1} )}^{2}}{{w}_{s} - 1}} \qquad ( 6 )$$

where \tilde{Q}ᵢ₌₁ is the mean of the data points in the data window Qᵢ₌₁, OPⱼ is the j^{th} data point in the data window Qᵢ₌₁.

The above calculations are repeated for Pᵢ₌₂ and Qᵢ₌₂, Pᵢ₌₃ and Qᵢ₌₃, etc., up to and including P_{i=M} and Q_{i=M}.

Once all of the standard deviations for each window are determined, step 112 involves determining the ratio (R) of std^{OP}/std^{pv} for each window as follows:

$${R}_{i = 1} = {std}_{i = 1}^{op} / {std}_{i = 1}^{pv} . \qquad ( 7 )$$

Step 114 involves determining stiction(S) for each window by comparing the standard deviation ratios for each window with the threshold β, which threshold is specified at the beginning of the method, whereby in step 116, stiction(S) is assigned a value of either 1 or 0, as follows:

$${S}_{i = 1} = \{ \begin{matrix}1 & if {R}_{i = 1} \geq β \\ 0 & if {R}_{i = 1} < β\end{matrix} . \qquad ( 8 )$$

If the valve stem is stuck and not moving in the Pᵢ₌₁ data window, the PV signal does not vary and is in steady state in the Pᵢ₌₁ data window. Therefore, stdᵢ₌₁^{pv}, is very small or close to zero. When the valve stem is idle, the PV signal is either above or below SP, hence, the controller tries to maintain PV at SP by constantly altering its output (OP). Therefore, when the PV signal is in steady state in the Pᵢ₌₁ data window, the OP signal is in non-steady state in the Qᵢ₌₁ data window. When this happens, the ratio Rᵢ₌₁ becomes a large number (because of the small number in its denominator) and exceeds the threshold β. When Rᵢ₌₁≥β, the variable S gets value of 1 to indicate that the valve stiction happens in the first data window of the PV and OP signals. If Rᵢ₌₁<β, then the valve stem is freely moving, hence, PV and OP continuously change (this is indicate by Sᵢ₌₁=0).

The second data window of the PV signal and the OP signal are considered to verify if the valve is sticky in this data window.

$${P}_{i = 2} = PV ( ( {w}_{s} + 1 ) : 2 * {w}_{s} ) \qquad ( 9 )$$

$${Q}_{i = 2} = O P ( ( {w}_{s} + 1 ) : 2 * {w}_{s} ) \qquad ( 10 )$$

Pᵢ₌₂ and Qᵢ₌₂ have the same number (i.e. wₛ) of data points. The above calculations are repeated and the condition given in Eq. (8) is verified. Based on Rᵢ₌₂, Sᵢ₌₂ becomes 1 or zero. The above calculations are repeated until the last wₛ data points (i.e., last window) of the PV signal and the OP signal are analyzed for the presence of stiction(S).

Once all the data windows of the PV and OP signals are analyzed, i.e., given a value of either 1 or 0, step 118 involves computing the stiction index (SI) as follows:

$$SI = \frac{( {S}_{1} + {S}_{2} + {S}_{3} + {S}_{4} + … + {S}_{M - 1} + {S}_{M}}{M} \qquad ( 11 )$$

where S₁, S₂, S₃, etc. are the stiction(S) values for each window and M is the number of data windows that the PV signal or the OP signal are separated into.

$$M = \frac{N}{{w}_{s}} \qquad ( 12 )$$

where N is the total number of data points in PV or OP.

If Sᵢ (i=1 to M) becomes one in at least one data window, then SI is greater than zero. The larger is SI value, the more frequently the valve stem is stuck within a given time period (or period of operation). If the control valve has no stiction, SI equals zero. The window size wₛ and the threshold β are crucial for the method to detect sticky valves. As previously mentioned, after rigorously testing the method on data taken from industrial control loops pertaining to refineries, oil sands industry, mining industry and paper industry, the window size of 7 (wₛ=7) and the threshold of 15 (β=15) were found to be optimal values. The same values will be used for each oscillating control loop that needs to be diagnosed. In one embodiment, a second threshold value Φ is provided, whereby if SI is equal to or exceed Φ, a signal is sent to an operator indicting that a valve gets stuck very frequently. It is understood that in this embodiment, Φ (second threshold value) will also be entered into the program by the user at the start of the method. Thus, SI determines the frequency of stiction and the tolerance for frequency of stiction is provided by the second threshold value Φ. It is understood that the value of Φ will depend upon the particular control loop and the degree of stiction tolerance for that particular control loop. For example, Φ could be 0.5, whereby if stiction is occurring at a frequency of 50% of the time or more, then a signal may be given to an operator that a plant shutdown may be necessary to address the sticky valve, e.g., replace or fix the sticky valve.

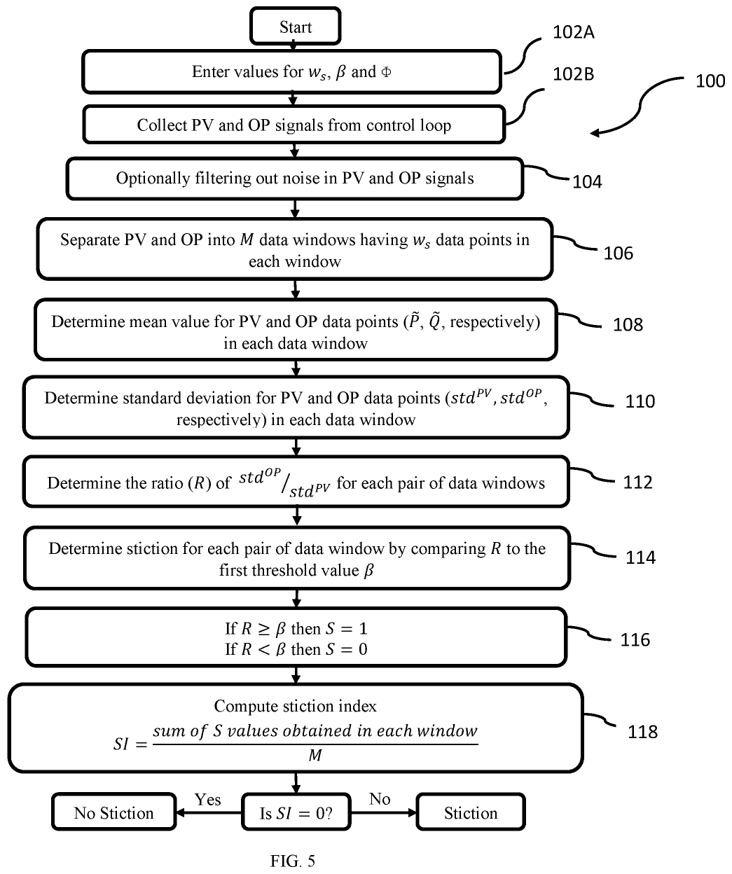

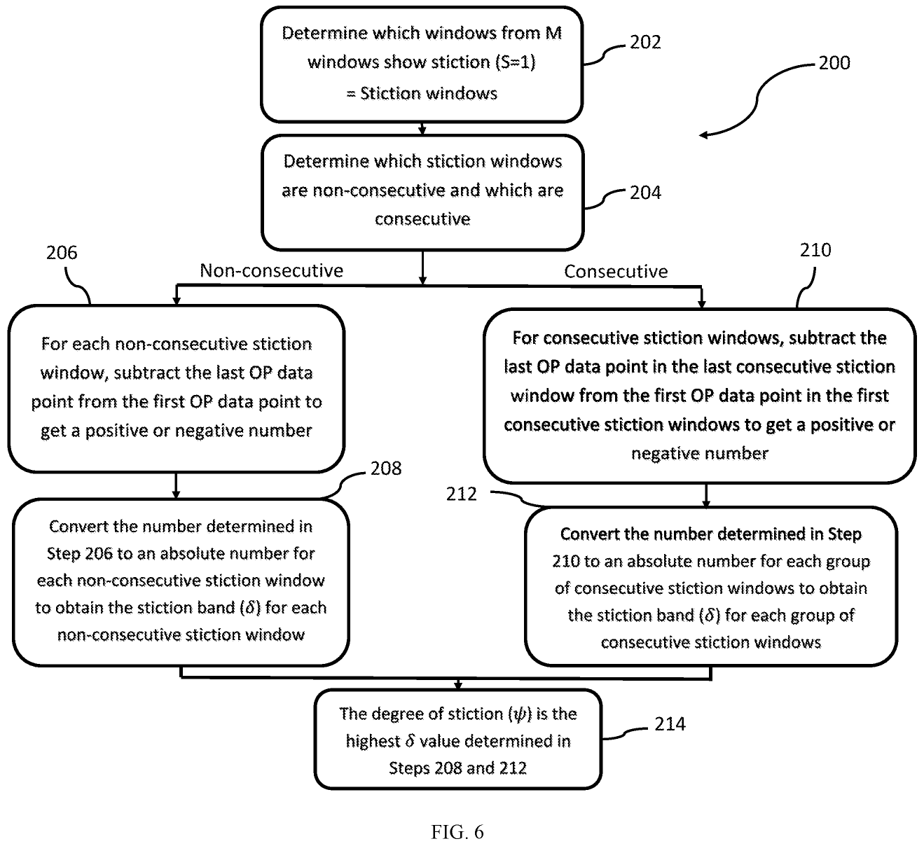

If the given control valve is found suffering from stiction, i.e., SI is greater than zero, it may be desirable to quantify the degree of stiction to timely notify panel operators of stiction severity, and assist plant maintenance engineers to arrange plant shutdowns well ahead in time. To this end, a procedure is provided, which is a byproduct of the method 100 for detecting valve stiction as explained above, to estimate the degree of stiction. FIG. 6 presents a flowchart of the stiction quantification procedure.

Stiction can be quantified using the method explained as follows. The stiction signal S plays a decisive role in estimating the degree of stiction of a given valve. With reference now to FIG. 6, the method 200 for determining the degree of stiction in a given valve comprises first step 202, where one determines which of the M windows show stiction, i.e., where S=1. These are referred to as “stiction windows”. It is understood that for any given valve there can be single, non-consecutive stiction windows, e.g., windows 1, 3, 5, 7, etc., where each stiction window is separated by at least one non-stiction window, or there may be consecutive (continuous) stiction windows, e.g., 3-4; 7-9; 11-12, etc., whereby there are two or more stiction windows in a row (consecutive), whereby the group of consecutive stiction windows is then separated from other individual stiction windows or group of stiction windows by a non-stiction window. Thus, step 204 involves determining which stiction windows are non-consecutive and which stiction windows are consecutive. For each non-consecutive stiction window, the last OP data point in that window is subtracted from the first OP data point in that window to give either a positive number or a negative number (step 206), which number is converted to an absolute number in step 208. The absolute number for each non-consecutive stiction window is designated as the stiction band (δ) for that particular non-consecutive stiction window. Similarly, for each group of consecutive (continuous) stiction windows, the last OP data point in the last stiction window of that group is subtracted from the first OP data point of the first stiction window of that group (step 210), which number is then converted to an absolute number in step 212. The absolute number for each group of consecutive stiction windows is also designated as the stiction band (δ) for that particular group of consecutive stiction windows. The stiction band (δ) indicates how serious valve stiction is, i.e., if δ is a very large number then stiction is very serious. The final step 214 is to determine the highest δ value of steps 208 and 210, inclusive, and this highest value is then referred to as the degree of stiction (Ψ). A tolerable degree of stiction (Ψ) will be process-specific and is generally specified by the user. If the degree of stiction (Ψ) exceeds this value, then this indicates a seriously sticky valve and operator intervention is likely necessary.

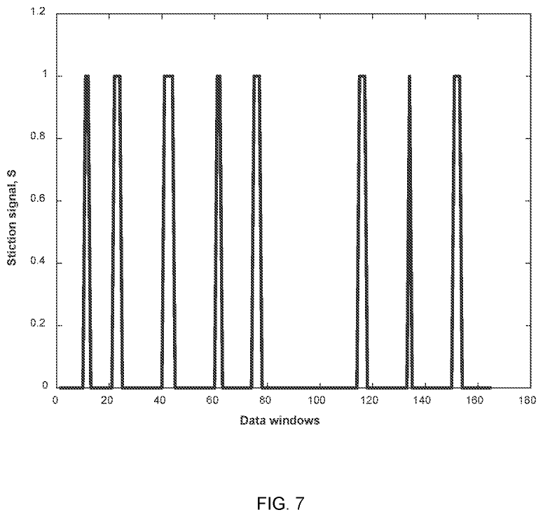

By way of example, suppose that the proposed method 100 yields the stiction signal shown in FIG. 7. The stiction signal S stays at zero in windows 1 through 10 but in windows 11 and 12, S takes value of one i.e. the valve sticks in this period. The stiction band in windows 11 and 12 is estimated as

$${δ}_{1} = \vert OP ( ( 11 - 1 ) \times {w}_{s} + 1 ) - OP ( 12 \times {w}_{s} ) \vert . \qquad ( 13 )$$

The control valve sticks at the first data point of the 11^{th} window, and overcomes stiction at the (12×wₛ+1)^{th} data point. The stiction signal immediately drops to zero and remains at zero in windows 13 through 21. The control valve again sticks in windows 22 through 24. Therefore, the stiction band in these windows is approximated as

$${δ}_{2} = \vert OP ( ( 22 - 1 ) \times {w}_{s} + 1 ) - OP ( 24 \times {w}_{s} ) \vert . \qquad ( 14 )$$

If the stiction signal S becomes one in only one window, the absolute value of the difference between OP at the first data point of this window and OP at the last data point of the window is the estimated as the stiction band. If the stiction signal S remains at one in more than one window (for example, windows 22, 23 and 24), the value of OP at the last data point of the last window (window 24) is subtracted from the value of OP at the first data point of the first window (i.e. window 22) and the absolute value of the result is considered as estimation for the stiction band. In this fashion, the stiction band in the remaining windows can be approximated. The following expression provides final estimation for degree of stiction.

$$Ψ = max \{ {δ}_{1} , {δ}_{2} , … , {δ}_{j} , {δ}_{j + 1} , … \} . \qquad ( 15 )$$

Once a sticky control valve is detected, it is up to panel operator to select right actions depending upon severity of stiction. The panel operator may like to leave corresponding control loop in automatic mode if the degree of stiction (Y) is small. In this situation, the performance of the control loop is decreased and the respective controller may need retuning. If the degree of stiction is abstemiously large, the sticky control valve may have to be put in manual operation mode (i.e. panel or field operator manually adjusts valve opening) until the valve is repaired or replaced, sooner or later.

### EXAMPLES

The method described in the present invention was assessed on a variety of control loop data acquired from chemical industry, paper industry, mining industry, and oil sands industry. Table 1 below provides details of the control loops studied.

TABLE 1
Details of control loops selected to test the method

| | Industry | | Actual |
|---|---|---|---|
| Loop name | Field | Control loop | malfunction |
| CHEM 1 | Chemicals | Flow control | Stiction |
| CHEM 10 | Chemicals | Pressure control | Stiction |
| MIN 1 | Mining | Temperature control | Stiction |
| CHEM 13 | Chemicals | Analyzer control | Faulty sensor |
| PAP 4 | Paper | Concentration control | Tight tuning |
| Example 6 | Chemicals | Flow control | Stiction |

The results obtained from the method described herein are summarized in Table 2 below and described in more detail as follows.

TABLE 2
Results obtained from the method

| | Stiction | | Verdict issued | Is diagnosis |
|---|---|---|---|---|
| Loop name | index (SI) | Estimated Ψ | by method | correct? |
| CHEM 1 | 7.8061 | 0.2385 | Stiction | Yes |
| CHEM 10 | 10.3030 | 0.3020 | Stiction | Yes |
| MIN 1 | 3.4169 | 0.3843 | Stiction | Yes |
| CHEM 13 | 0 | 0 | No stiction | Yes |
| PAP 4 | 0 | 0 | No stiction | Yes |
| Example 6 | 4.5444 | 8.1107 | Stiction | Yes |

### Example 1

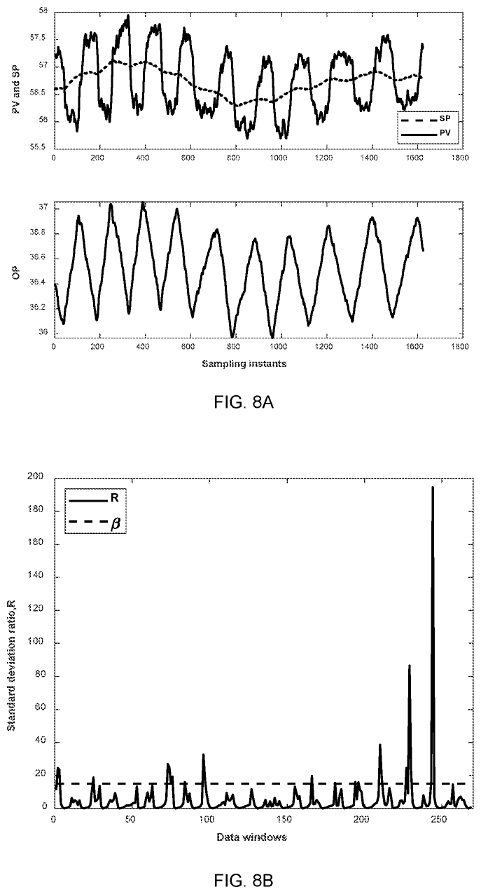

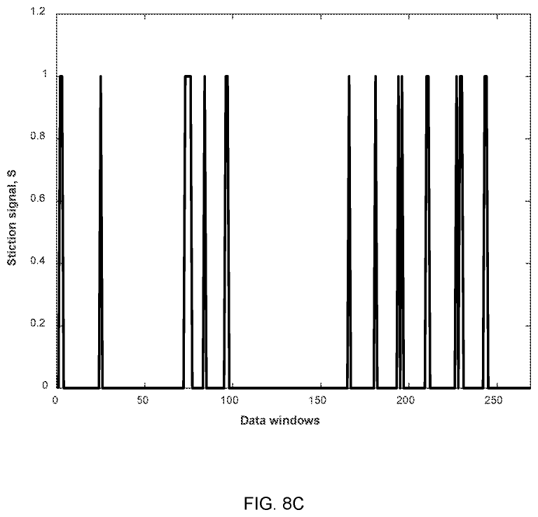

For CHEM 1 (flow control loop), FIG. 8A shows the time trends of PV, SP and OP. FIG. 8B and FIG. 8C display the standard deviation ratio (R) and the stiction signal(S) obtained from the method. It can be noticed that, in some data windows, R surpasses the threshold (β) (consequently, S becomes one in those data windows) that indicates the control valve is sticky in those data windows, which is confirmed by the numerical results given in Table 2 (first row). The diagnosis made by the method of the present invention is in agreement with the actual malfunction.

### Example 2

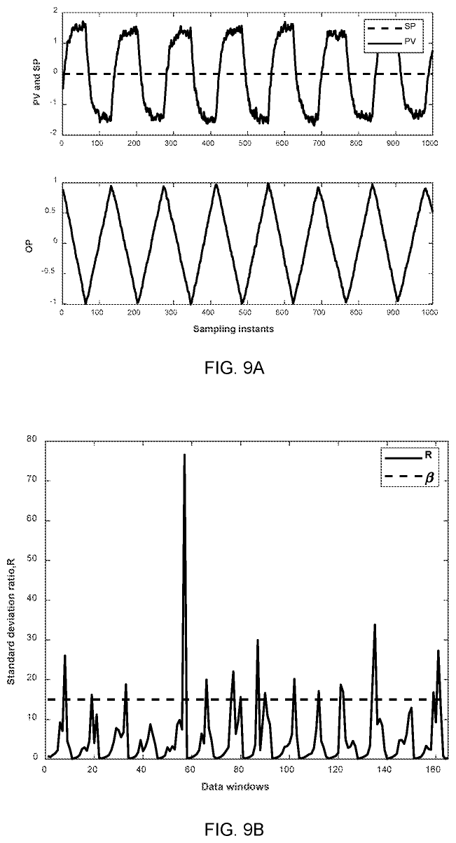

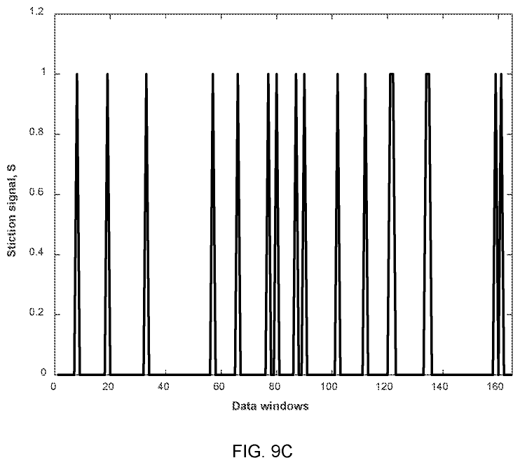

For CHEM 10, FIG. 9A provides the closed loop signals of the pressure control loop. The PV signal has obvious steady state periods (because of valve stiction) and, in the corresponding regions, the OP signal has noteworthy variations. According to FIG. 9B, FIG. 9C and Table 2 (2^{nd} row), all of the occurrences of valve stiction are captured by the method. Therefore, the method correctly detected the root cause of the oscillations.

### Example 3

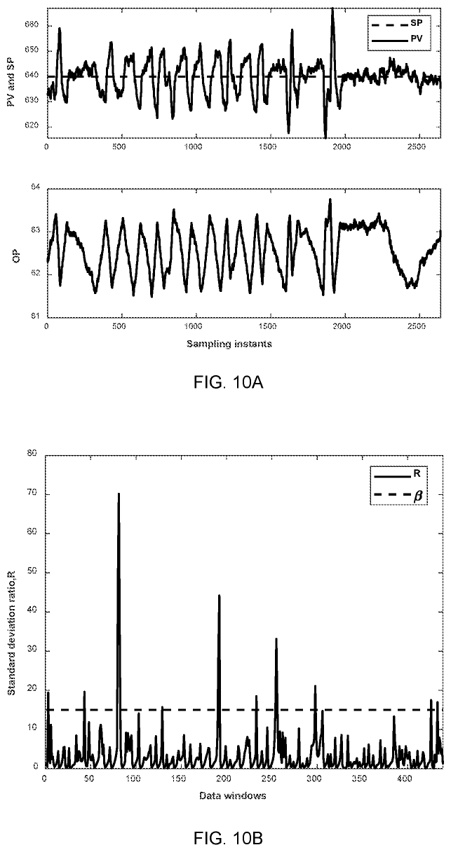

The closed loop signals of the temperature control loop (MIN 1) and the obtained results are given in FIG. 10A, FIG. 10B, FIG. 10C and Table 2 (third row). In this case study too, the method provided correct diagnosis.

### Example 4

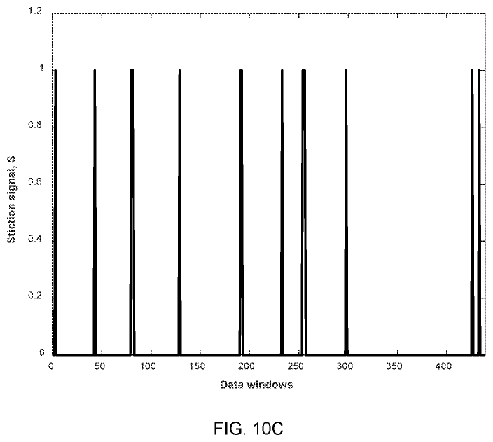

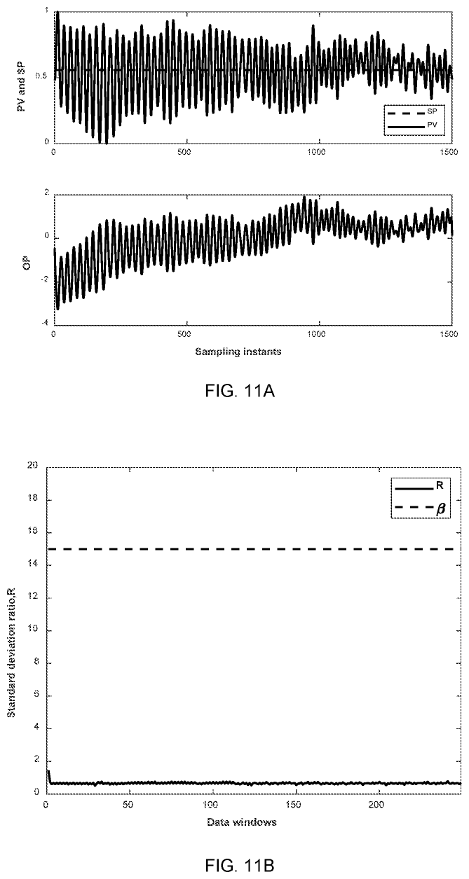

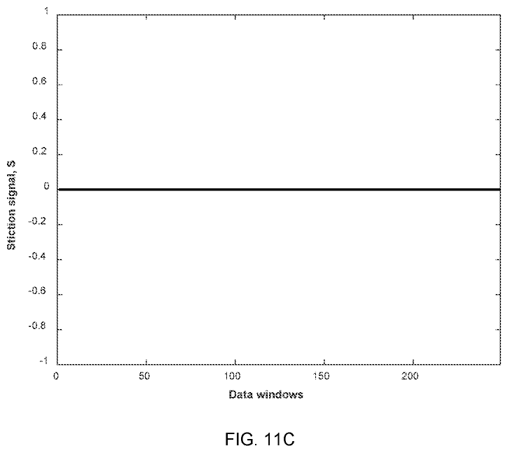

For CHEM 13, the closed loop signals of the analyzer control loop are shown in FIG. 11A. According to the closed loop signals, the PV signal has no steady state periods. Both the PV and OP signals are changing with time. The standard deviation ratio given in FIG. 11B stays below the threshold in each of the data windows. Hence, the stiction signal(S) (shown in FIG. 11C) remains at zero. The stiction index (SI) (given in the fourth row of Table 2) is zero that signifies the absence of valve stiction.

### Example 5

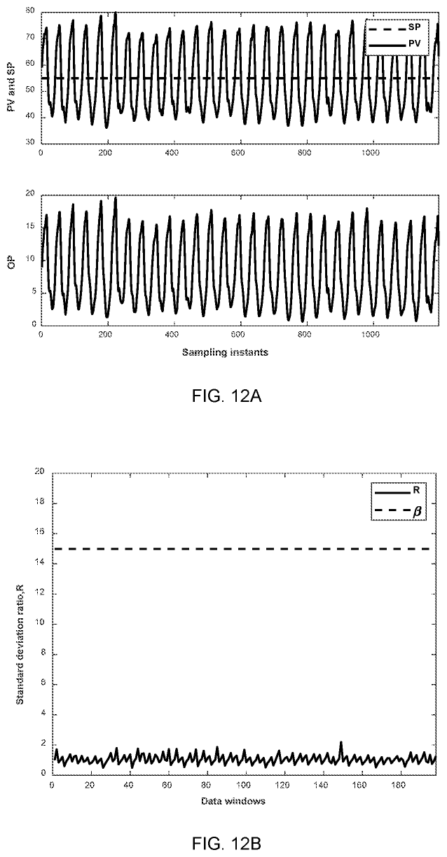

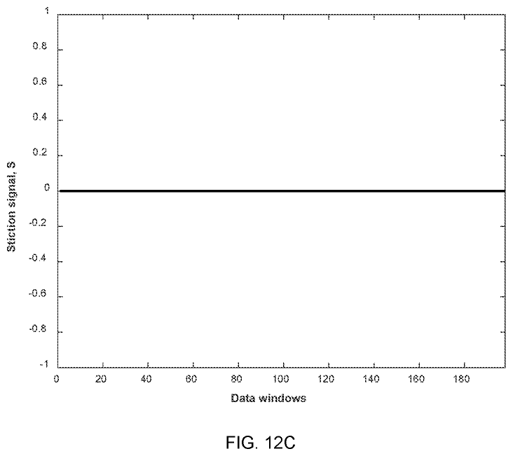

FIG. 12A, FIG. 12B, FIG. 12C and Table 2 (fifth row) provide the closed loop signals and the results for the concentration control loop (PAP 4). The results suggest that the control valve has no stiction.

### Example 6

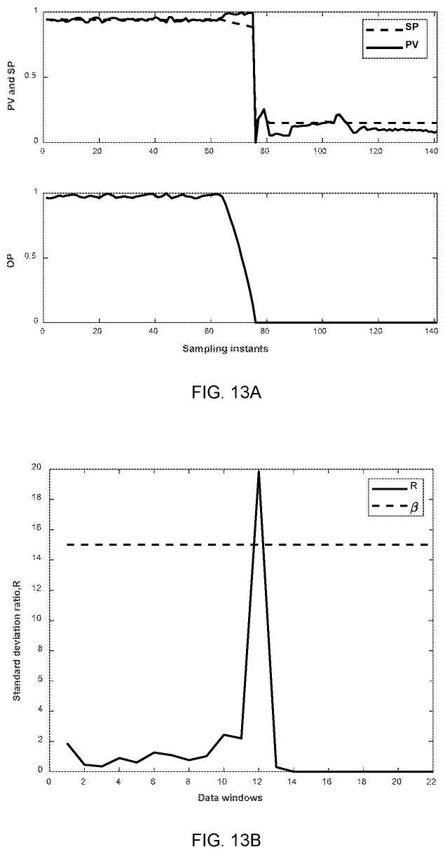

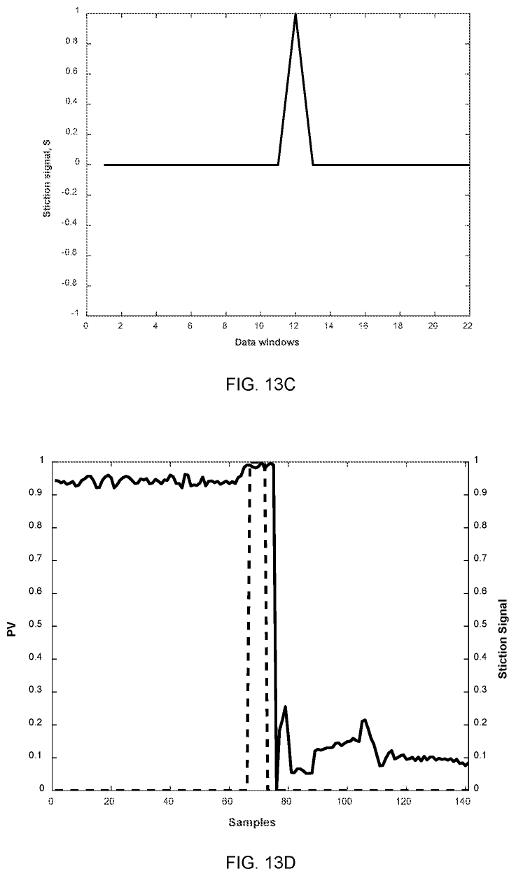

The closed loop signals of a steam flow control loop shown in FIG. 13A was adopted from an oil sands industry. The steam combines with the treated feed gas, upstream of a packed bed reactor, in mixed tee to form a mixed stream. From FIG. 13A, it is noticed that PV follows SP until the 63^{rd} sample, and then both PV and SP change in the opposite direction for some time due to process disturbances. At around the 64^{th} sample, the steam controller starts closing the steam control valve slowly; as a result, OP keeps decreasing, but PV did not follow the OP change due to severe valve stiction. When OP dropped large enough, it caused sudden movement in the steam valve, and thus steam flow was reduced to below its trip set point, which resulted in plant trip. The PV signal and the OP signal do not oscillate like the control loops studied in Case Studies 1 to 5. In spite of the absence of the oscillations, as per the results shown in FIG. 13B, FIG. 13C, FIG. 13D and Table 2 (sixth row), the method given in the present invention detected severe valve stiction.

### Interpretation

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

### REFERENCES

1. Md Ali A. Shoukat Choudhury, Sirish L. Shah, David Shook, Nina F. Thornhill. “Detection and quantification of stiction”. Canada Patent No. 2,571,022, issued Jun. 10, 2014.
2. Sun, X., Shah, A., Amalraj, J. “Furnace Combustion Cross Limit Control with Real Time Diagnostic Features”. Canada Patent No. 2,870,918, issued Jan. 10, 2017.
3. Angelo Basa Florentino, Prakash Mariappan. “Method for detection of diagnosing control valve stiction”. European Patent No. 3,252,557, issued Dec. 6, 2017.
4. Charles Q. Zhan, Joseph Z Lu. “Apparatus and method for identifying possible defect indicators for a valve”. U.S. Pat. No. 7,274,995, issued Sep. 25, 2007.
5. Michael Boken. “Valve monitoring system and method”. U.S. Pat. No. 7,318,350, issued Jan. 15, 2008.
6. Ashish Singhal, Timothy I. Salsbury. “Method and apparatus for evaluating the performance of a control system”. U.S. Pat. No. 7,865,334, issued Jan. 4, 2011.
7. Sankar Selvaraj, Lakshmi Kiran Kanchi, Ching Hua Joseph Lee. “Method and apparatus for qualifying performance of a conventional control valve”. U.S. Pat. No. 9,429,938, issued Aug. 30, 2016.
8. Da zheng, Xi Sun, Seshu K. Damarla, Ashish Shah, Joseph Amalraj, Biao Huang. “Valve Stiction Detection and Quantification Using a K-Means Clustering Based Moving Window Approach”. Industrial & Engineering Chemistry Research, Vol. 60 (6), pp. 2563-2577, 2021.
9. Seshu K. Damarla, Xi Sun, Fangwei Xu, Ashish Shah, Joseph Amalraj. “A practical linear regression based method for detection and quantification of stiction in control valves”. Industrial & Engineering Chemistry Research, Vol. 61 (1), pp. 502-514, 2022.
10. Seshu K. Damarla, Xi Sun, Fangwei Xu, Ashish Shah, Biao Huang. “A sigmoid function based method for detection of stiction in control valves”. In Proceedings of 7th International Symposium on Advanced Control of Industrial Processes, Aug. 7-9, 2022, University of British Columbia, Canada.
11. Md Ali A. Shoukat Choudhury, Nina F. Thornhill, Sirish L. Shah. “AutomaticDetection and Quantification of Control Valve Stiction.” Contr. Eng. Pract., Vol. 14, pp. 1395-1412, 2006.
12. Mohieddine Jelali and Biao Huang. Detection and Diagnosis of Stiction in Control Loops: State of the Art and Advanced Methods; Springer-Verlag: London, 2009; pp 1-389.

1. A method for identifying a malfunctioning control valve due to stiction in a process control loop, the process control loop having a sensor for measuring a process parameter or variable (PV) and a controller for controlling the control valve, comprising the steps of:
(a) providing a set point value (SP) for a stable operation of the process, where the controller compares the process parameter or variable (PV) with the SP and provides an output signal (OP) for controlling the control valve;
(b) collecting PV and OP signals from the control loop for a period of time;
(c) dividing the PV signal and the OP signal into a number (M) of non-overlapping data windows, each PV or OP data window having a number (wₛ) of distinct PV or OP data points;
(d) determining the mean value of the PV and OP data points in each of the PV and OP data windows;
(e) computing a standard deviation of the PV data points present in each of the PV windows (STD_{PV}) and a standard deviation of the OP data points in each of the OP windows (STD_{OP});
(f) calculating and storing a standard deviation ratio (R) (STD_{OP}/STD_{PV}) for each OP/PV window pair;
(g) computing stiction(S) in each OP/PV window pair by comparing the standard deviation ratios (R) of each PV/OP window pair to a first predefined threshold value (β) and if the standard deviation ratio (R) is equal to or greater than β then S is 1 and if the standard deviation ratio (R) is less than β then S is 0; and
(h) computing a stiction index (SI) by adding the S values obtained in each OP/PV window pair divided by the number of windows (M);
whereby when SI is 0 there is no stiction and when SI is greater than zero there is stiction.

2. The method according to claim 1, further comprising filtering out noise in the PV signals prior to step (c).

3. The method according to claim 1, further comprising comparing SI to a second predefined threshold value (Φ), whereby if SI is equal to or greater than Φ an operator receives a signal indicating that the control valve frequently gets stuck in a given period of operation.

4. The method according to claim 1, further comprising quantifying a degree of stiction (Ψ) for the control valve.

5. The method according to claim 4, whereby the degree of stiction (Ψ) is quantified by:
(i) determining which of the M windows have an S value equal to 1, which windows are referred to as stiction windows;
(j) determining which stiction windows are non-consecutive and which stiction windows are consecutive;
(k) for each non-consecutive stiction window, subtract the last OP data point in that window from the first OP data point in that window and convert the resulting number to an absolute number to obtain a stiction band value (δ) for each non-consecutive window;
(l) for each group of consecutive stiction windows, subtract the last OP data point in the last consecutive stiction window of that group from the first OP data point in the first consecutive stiction window of that group and convert the resulting number to an absolute number to obtain a stiction band value (δ) for each group of consecutive windows;
whereby the degree of stiction (Ψ) is the highest stiction band value (δ) determined in steps (k) and (l).
